(19) United States
(12) Patent Application Publication
(10) Pub. No.: US 2024/0060534 A1
(43) Pub. Date: Feb. 22, 2024

(54) WEB-TYPE BEARING FOR SUPPORTING A VEHICLE PART

(71) Applicant: Vibracoustic SE, Darmstadt (DE)

(72) Inventors: David Rose, Hamburg (DE); Hilrich Kardoes, Winsen (DE); Jakob Friess, Stelle (DE); Philipp Werner, Lüneburg (DE)

(21) Appl. No.: 18/234,119

(22) Filed: Aug. 15, 2023

(30) Foreign Application Priority Data
Aug. 16, 2022 (DE) 10 2022 120 686.6

(51) Int. Cl. F16C 33/20

(52) U.S. Cl. CPC F16C 33/20

(57) ABSTRACT

The invention involves a bearing bush for supporting a vehicle part on a vehicle body. In embodiments, a bearing bush includes a core, which extends along a central longitudinal axis of the bearing bush, and an outer sleeve, which surrounds the core circumferentially. In embodiments, an elastomer body is arranged between the core and the outer sleeve; the elastomer body comprises at least four webs, each having a centerline; and/or longitudinal centerlines of the at least four webs are not directed toward the central longitudinal axis of the bearing bush.

### CROSS-REFERENCE TO RELATED APPLICATION

This application claims priority to German Patent Application No. DE 10 2022 120 686.6, filed on Aug. 16, 2022, the contents of which is hereby incorporated by reference in its entirety.

### TECHNICAL FIELD

The invention relates to a bearing bush for supporting a vehicle part on a vehicle body.

### BACKGROUND

With the aid of common bearing bushings for mounting vehicle parts on a vehicle body, vehicle parts, such as, for example, internal combustion engines, electric motors or transmissions, can be attached to the body in a damping manner, thereby making it possible to isolate the vibrations generated by the respective vehicle part. In this way, an increase in driving comfort is achieved.

The bearing bushes known in the prior art are usually traversed by a central longitudinal axis and comprise a core, which extends along the central longitudinal axis, an outer sleeve, which is arranged circumferentially with respect to the core, thus forming an intermediate region, and at least one elastomer body, which is arranged between the core and the outer sleeve. In this case, the elastomer body can have webs which run in a radial direction with respect to the central longitudinal axis and span the intermediate region.

Thus, EP 1306573 A1, for example, discloses a bearing bush having an elastomer comprising radially extending webs. Here, the axes of symmetry of the elastic webs run through the central point of the bush, i.e. the webs are arranged exactly radially. As a result, on the one hand, it is primarily shear stresses that are induced in the elastomer in the case of torsional movements, and therefore it is virtually impossible to achieve a progressive stiffness curve in the direction of torsion by means of increasing induced compressive stresses, which contribute particularly to progressive behavior. On the other hand, high shear components and some compression are induced in the elastomer in the case of a radial load, although higher compression components would also be advantageous here for some applications. One of the effects of this behavior is that it is primarily shear forces which occur in known solutions with radially extending webs, even with calibration, and these forces prevent good calibration of the bearing bush.

The known bearing bushes vibrate with a natural frequency, which may have an undesirably large amplitude or occurs in an unwanted frequency range. If the natural frequency of the bearing bush and an excitation frequency caused by the vehicle part are superposed, this may result in a resonance.

It is an object of the invention to provide a bearing by means of which the disadvantages in the prior art can be reduced or eliminated and which ensures reliable and stable centering of the core. At the same time, the bearing should allow good transfer of torsional movements into the elastomer body by being torsionally flexible around the design location but having increasing torsional stiffness as the torsional deflection increases.

### SUMMARY

Aspects and features of the invention are disclosed herein.

Advantages associated with the invention may be achieved by a bearing bush for supporting a vehicle part on a vehicle body, comprising a core, which extends along a central longitudinal axis of the bearing bush, and an outer sleeve, which surrounds the core circumferentially, wherein an elastomer body is arranged between the core and the outer sleeve, wherein the elastomer body comprises at least four webs, and wherein each web has a longitudinal centerline. The bearing bush is distinguished by the fact that the longitudinal centerlines of at least four webs are not directed toward the central longitudinal axis of the bearing bush. Instead, the at least four webs of the bearing bush, which are not directed toward the central longitudinal axis of the bearing bush, are arranged in such a way that their longitudinal centerlines are directed eccentrically, i.e. not toward the central point of the bearing bush (in the cross section of the bearing bush). The longitudinal centerlines of the webs, which are not directed toward the central longitudinal axis of the bearing bush, thus slope at an angle α relative to the radius of the bearing bush. As a consequence, the longitudinal centerlines do not all meet at a common central point.

Theoretically, there can also be additional webs which are directed toward the central point of the bush, for example. However, webs of this kind are not of significance to the solution of the underlying problem as long as at least four webs of the bush are arranged in such a way that their longitudinal centerlines are not directed toward the central longitudinal axis of the bearing bush.

In this context, the longitudinal centerline of a web should be taken to mean the longitudinal axis of the web which runs from the outer sleeve to the core, wherein it runs through the center of the contact region of the web with the outer sleeve and through the center of the contact region of the web with the core. If the web is mirror-symmetrical and constructed with straight lateral surfaces, the longitudinal centerline corresponds to the axis of symmetry of the web in the longitudinal direction.

The bearing bush according to the invention ensures that the core undergoes reliable centering within the bush. Owing to their special arrangement—almost radial but not directed toward the central point or the central longitudinal axis of the bush—the webs, which are not directed toward the central longitudinal axis of the bearing bush, ensure that, instead of primarily shear stresses, the torsional movements of the bearing bush now also induce compressive stress components in the webs.

A bearing bush having an elastomer body configured in this way furthermore has the effect that the core is self-centering with respect to oblique and/or superposed radial movements. In addition, the bush according to the invention ensures a good capacity for inducing compressive stresses and a good capacity for adjustment of the stiffness progression of the elastomer body in the radial direction.

The elastomer body may comprise four webs, which are arranged approximately in an x shape, i.e. approximately radially, in the bearing bush. In this case, two webs are arranged to the left of a vertical plane of the bearing bush, and two webs are arranged to the right of the vertical plane. Here, the term “vertical plane” relates to the illustration of the bush in the figures and should not necessarily be taken as equivalent to the vertical of the respective vehicle in which the bush is installed. Here, the fact that the longitudinal centerlines or axes of symmetry of the webs do not run through the central longitudinal axis of the bearing bush has the result that the longitudinal centerlines of the four webs do not converge at the central point of the bush. Instead, it is envisaged, for example, that the longitudinal centerlines of the two webs to the left of the vertical plane converge at a left-hand point of intersection and that the longitudinal centerlines of the two webs to the right of the vertical plane converge at a right-hand point of intersection, wherein the left-hand and the right-hand points of intersection are each located in the horizontal plane of the bearing bush. In this case, the left-hand point of intersection is situated to the left of the central longitudinal axis in the horizontal plane, and the right-hand point of intersection is situated to the right of the central longitudinal axis in the horizontal plane.

The fact that the longitudinal centerlines of the webs do not run through the central longitudinal axis of the bearing bush and that they do not intersect the central longitudinal axis furthermore means that they do not run exactly along a radius of the bush but that they are arranged at an angle α to the radius.

The elastomer body can advantageously connect the core and the outer sleeve to one another. For example, the elastomer body can be attached to the inner surface of the outer sleeve and to the outer surface of the core, e.g. by vulcanization. The elastomer element can completely fill the intermediate region between the outer sleeve and the core in the region of a respective web.

The webs can substantially completely span the intermediate region in the radial direction. At the same time, a longitudinal free space can be formed in the intermediate region between webs that are adjacent in the circumferential direction, said space may be formed over the entire longitudinal extent of respective adjacent webs. In this case, the longitudinal free space can be delimited by the core, the outer sleeve and the two adjacent webs. The longitudinal free space can furthermore be designed as a through-aperture which is open at both end faces of the bearing bush. In the case of embodiments of this kind, each web extends from one end face of the bush to the other.

According to a further development, provision can be made for each web to have a length and a width in the cross section of the bearing bush, the ratio of the length to the width being at least 1.0. In other words: the length of each web is at least equal to its width in the cross section of the bearing bush. According to an embodiment, the ratio of the length to the width of each web is at least 1.5. According to an embodiment, the ratio of the length to the width of each web is at least 2. In this context, the length of a web should be taken to mean the smallest distance between the inner side of the outer sleeve and the outer surface of the core along the longitudinal centerline of the web. The width of a web is defined as the distance in the circumferential direction between the two lateral surfaces at the ends of the web at its narrowest point. If the length of the webs is at least equal to their width, they provide long spring travels. This enables large radial deflections of the bush to be tolerated.

Provision can furthermore be made for each web to be wider in the contact region with the outer sleeve than in the contact region with the core in the cross section of the bush. The webs thus taper in the direction of the core. In this way, it is possible to prevent buckling of the webs and to increase the stiffness progression.

Furthermore, the outer sleeve can have a substantially cylindrical shape, wherein the cylinder comprises two half-shells, which are separated from one another by a gap and are situated diametrically opposite one another. The gap can also be referred to as the half-shell parting plane. Using separate half-shells makes it possible to achieve directional calibration in the closing direction during press fitting, or during the closure of the gap. This induces compressive stresses in the elastomer body. It is thereby advantageously possible to increase its service life. This furthermore enables the desired stiffness of the bearing bush to be set.

The webs of the elastomer body are advantageously arranged in the bearing bush in such a way that they do not run along a vertical plane of the bush. Instead, the webs should be angled with respect to the vertical plane. Here, the vertical plane is defined as the plane which is perpendicular to a half-shell parting plane (also referred to as the horizontal plane). The vertical plane thus corresponds to the direction of calibration, i.e. the direction of movement at the split half-shells toward one another, when they are pressed together before press fitting. The webs may form an angle α of between 10° and 80° to the vertical plane. In this way, it is possible to ensure reliable guidance of the core in the horizontal direction.

In order to be able to counteract excessive radial deflection of the core in relation to the compressed half-shells, provision can be made for at least one elastomer stop buffer to be provided on the inside of the half-shells, either in the region of the two ends thereof or between the two webs. The stop buffer makes it possible to limit the radial deflection. The stop buffers may be formed integrally with the elastomer body and project from the inner side of the outer sleeve or of each half-shell in the direction of the core.

Provision can furthermore be made for the stop buffer to project substantially radially in the direction of the central longitudinal axis. Each half-shell may have a stop buffer of this kind, wherein, for example, the stop buffers are arranged in the vertical plane of the bearing bush or the horizontal plane.

In cross section, the core may have an outer surface which, in cross section, in each case very largely corresponds in the region of the attachment surface of the webs to the curvature of the outer sleeve. However, it is also conceivable for the core to have a different curvature than the outer sleeve. Thus, in cross section, the core can for example have an approximately oval or elliptical shape, whereas the outer sleeve has a very largely circular shape, or vice versa. It is also possible for the outer surface of the core and/or the inner surface of the outer sleeve to be approximately rectangular, elliptical or oval in a cross-sectional view. The rectangular, elliptical or oval shape of the core leads to advantageous adaptations of the compression, shear and tensile stress conditions, depending on the load case.

Further features, details and advantages of the invention can be derived from the claims and from the following description of embodiments with reference to the drawings.

### BRIEF DESCRIPTION OF THE DRAWINGS

FIG. 1 shows a cross-sectional view of an embodiment of a bearing bush according to aspects and teachings of the disclosure in a schematic illustration.

### DETAILED DESCRIPTION

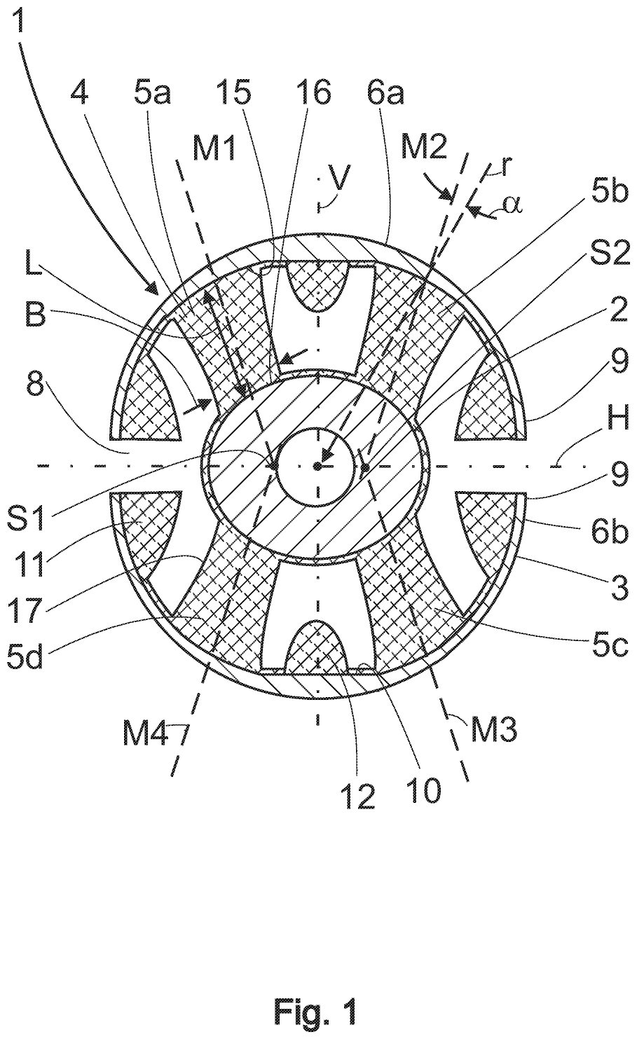

FIG. 1 shows a cross-sectional view of an embodiment of the bearing bush 1 according to aspects and teachings of the disclosure in a schematic illustration. The example shown in FIG. 1 comprises an oval or elliptical core 2, which extends along a central longitudinal axis Z of the bearing bush. Since FIG. 1 is a cross-sectional view which runs perpendicularly to the central longitudinal axis Z, the central axis Z is accordingly illustrated only as a point. The core 2 is surrounded circumferentially by an outer sleeve 3, wherein an elastomer body 4 is arranged between the core 2 and the outer sleeve 3.

The elastomer body 4 comprises four webs 5a-d, which run approximately radially from the inner side 10 of the outer sleeve 3 to the circumferential surface of the core 2. Each web 5a-d has a longitudinal centerline M1-4. As can be seen in FIG. 1, the longitudinal centerlines M1-4 of the webs 5a-d do not run through the central longitudinal axis Z of the bearing bush 1. Instead, the webs 5a-d of the elastomer body 4 are arranged in such a way that their longitudinal centerlines M1-4 bypass the central longitudinal axis Z. The longitudinal centerlines M1-4 of the webs are therefore eccentric, i.e. they are not directed toward the central point of the bearing bush 1 (point Z in the cross section of the bearing bush 1). In other words: the longitudinal centerlines M1-4 of the webs 5a-d slope relative to true radii.

In the bearing bush 1 shown in FIG. 1, the core 2 can be reliably centered in the interior of the sleeve 3. Here, by virtue of their special arrangement, the webs 5a-d ensure that, in addition to shear stresses, torsional movements of the bearing bush 1 also induce compressive stresses in the webs 5a-d. In addition, by virtue of their configuration, the webs 5a-d ensure that the core 2 is self-centering with respect to oblique and/or superposed radial movements.

As shown in FIG. 1, the webs 5a-d are arranged substantially in an x shape in the bearing bush 1, wherein the longitudinal centerlines M1-4 of each pair of diagonally opposite webs 5a, 5c and 5b, 5d do not meet at a common point. Instead, longitudinal centerline M1 runs parallel to longitudinal centerline M3, and longitudinal centerline M2 runs parallel to longitudinal centerline M4. Moreover, two webs 5a,d are arranged to the left of the vertical plane V of the bearing bush 1, and two webs 5b,c are arranged to the right of the vertical plane V. In this case, the longitudinal centerlines M1,4 of the two webs 5a,d to the left of the vertical plane V meet in horizontal plane H at a first point of intersection S1 to the left of the central longitudinal axis Z, and the longitudinal centerlines M2,3 of the two webs 5b,c to the right of the vertical plane V intersect in horizontal plane H at a second point of intersection S2, which is situated to the right of the central longitudinal axis Z. Owing to the fact that the longitudinal centerlines M1-4 of the webs 5a-d do not run through the central point Z of the bearing bush 1, the first point of intersection and the second point of intersection are also not congruent.

The webs 5a-d of the bearing bush 1 shown in FIG. 1 are furthermore not of mirror-symmetrical configuration. Instead, each web 5a-d has a concave shape, i.e. the two side walls 17 of each web 5a-d are arched inward or recessed. This can be advantageous under radial loading as regards buckling and hence as regards the service life.

Furthermore, the outer sleeve 3 of the bearing bush 1 shown in FIG. 1 comprises two half-shells 6a,b, which are separated by a gap 8. Here, the two half-shells 6a,b are connected to the elastomer body 4 in such a way that they substantially form a cylinder (a circle in the cross-sectional view). The two half-shells 6a,b shown in FIG. 1 are of equal size and are situated diametrically opposite one another. The use of separate half-shells 6a,b enables the stiffness of the bearing bush 1 to the adjusted particularly easily. In this case, the outer sleeve does not have a constant wall thickness. On the contrary, the corresponding attachment surfaces of the webs to the outer sleeve and the core have the same curvature. This is advantageous if a high compression stiffness of the webs is desired.

According to the example from FIG. 1, the webs 5a-d of the elastomer body 4 are arranged in the bearing bush 1 in such a way that they do not run along the vertical plane V of the bush 1. Instead, the webs 5a-d slope at an angle α of about 20° to the vertical plane V, wherein the angle α relates to the slope of the respective longitudinal centerline M1-4 with respect to the vertical plane V.

The core 2 of the bearing bush 1 is connected by the elastomer body 4 to the half-shells 6a,b of the outer sleeve 3. For this purpose, the elastomer body 4 is attached to the inner side 10 of the outer sleeve 3 and to the outer surface of the core 2, e.g. by vulcanization. In this case, the attachment sections of a respective web 5a-d can coincide, at least sectionwise, with the core 2 and the inner side 10 of the outer sleeve 3, respectively, in the radial direction R. The elastomer body 4 can completely fill the intermediate region between the outer sleeve 3 and the core 2 in the region of a respective web 5a,b.

The webs 5a-d of the bearing 1 from FIG. 1 span the intermediate region substantially completely in the radial direction R. In this case, a free space is formed in the intermediate region between webs 5a-d that are adjacent in the circumferential direction, said free space being delimited by the core 2, the outer sleeve 3 and the two adjacent webs 5a-d.

In cross section, the webs 5a-d of the example shown in FIG. 1 furthermore have a length L and a width B, wherein the ratio of the length L to the width B is about 3.0, i.e. the length of each web 5a-d is approximately three times the width in cross section. Webs 5a-d configured in this way offer long spring travels. This enables large radial deflections of the bush 1 to be tolerated.

Moreover, the webs 5a-d of the embodiment in FIG. 1 are wider in the contact region with the outer sleeve 15 than in the contact region with the core 16. The webs 5a-d thus taper in the direction of the core 2. This is a simple way of preventing the webs 5a-d from buckling.

To enable excessive radial deflection of the core 2 to be counteracted, both half-shells 6a,b have a stop buffer 11 on the inner side 10 in the region of their two ends 9 and stop buffers 12 made of an elastomer material between the webs. The stop buffers 11 and/or 12 make it possible to limit the radial defections in a particularly efficient way. The stop buffers 11 and/or 12 project from the inner side 10 of the outer sleeve 3 in the direction of the core 2.

The invention is not restricted to the above-described embodiments but can be modified in a variety of ways.

All the features and advantages which emerge from the claims, the description and the drawing, including design details, spatial arrangements and method steps, may be essential to the invention either per se or in a wide variety of combinations.

1. A bearing bush for supporting a vehicle part on a vehicle body, comprising:
a core that extends along a central longitudinal axis of the bearing bush, and
an outer sleeve that surrounds the core circumferentially,
wherein an elastomer body is arranged between the core and the outer sleeve; the elastomer body comprises at least four webs, each of the at least four webs having a centerline; and longitudinal centerlines of the at least four webs are not directed toward the central longitudinal axis of the bearing bush.

2. The bearing bush as claimed in claim 1, wherein the elastomer body connects the core and the outer sleeve to one another.

3. The bearing bush as claimed in claim 1, wherein each web has a length and a width in cross section, a ratio of the length to the width being at least 1.0.

4. The bearing bush as claimed in claim 1, wherein each web is wider in a contact region with the outer sleeve than in the contact region with the core.

5. The bearing bush as claimed in claim 1, wherein the outer sleeve comprises two half-shells, the two half-shells being separated from one another by a gap.

6. The bearing bush as claimed in claim 5, wherein at least one of the half-shells has a respective end stop on an inner side in a region of each of its two ends.

7. The bearing bush as claimed in any one of claim 5, wherein at least one of the half-shells has, on an inner side of the outer sleeve, a stop buffer in a region between two webs.

8. The bearing bush as claimed in claim 7, wherein the stop buffer projects substantially in a radial direction of the central longitudinal axis.
